(19) United States
(12) Patent Application Publication
(10) Pub. No.: US 2026/0017335 A1
(43) Pub. Date: Jan. 15, 2026

(54) OPTIMIZATION SUPPORT DEVICE, OPTIMIZATION SUPPORT METHOD, AND RECORDING MEDIUM

(71) Applicant: NEC Corporation, Tokyo (JP)

(72) Inventor: Koji ICHIKAWA, Tokyo (JP)

(73) Assignee: NEC Corporation, Tokyo (JP)

(21) Appl. No.: 19/248,602

(22) Filed: Jun. 25, 2025

(30) Foreign Application Priority Data
Jul. 12, 2024 (JP) 2024-112209

(51) Int. Cl. G06F 17/11

(52) U.S. Cl. CPC G06F 17/11

(57) ABSTRACT

An optimization support device includes an acquisition unit, a conversion unit, a selection unit, and an output unit. The acquisition unit acquires information regarding a problem to be optimized. The conversion unit converts the information regarding the problem to be optimized into an intermediate expression representing a feature of the information regarding the problem to be optimized. The selection unit selects a solution to be applied to the problem to be optimized from the solutions associated with the intermediate expression representing the feature of the problem suitable for application based on the converted intermediate expression for decision making. The output unit outputs information regarding the selected solution.

This application is based upon and claims the benefit of priority from Japanese Patent Application No. 2024-112209, filed on Jul. 12, 2024, the disclosure of which is incorporated herein in its entirety by reference.

### TECHNICAL FIELD

The present disclosure relates to an optimization support device and the like.

### BACKGROUND ART

In the optimization problem, for example, a solution to the problem to be optimized is derived by applying a solution relevant to the problem to be optimized. The retrieval device of WO 2023/286171 A1 acquires data indicating a feature of a problem to be optimized Then, the retrieval device of WO 2023/286171 A1 retrieves, from the database, an optimization problem associated with data that matches data indicating a feature of the problem to be optimized.

### SUMMARY

An object of the present disclosure is to provide an optimization support device and the like that can easily select a solution suitable for a problem to be optimized.

An optimization support device according to an aspect of the present disclosure includes: an acquisition that acquires information regarding a problem to be optimized; a conversion unit that converts information regarding the problem to be optimized into an intermediate expression representing a feature of the information regarding the problem to be optimized; a selection unit that select, based on the converted intermediate expression, a solution to be applied to the problem to be optimized from a solution associated with an intermediate expression representing a feature of a problem suitable for application; and an output unit that outputs information regarding the selected solution.

An optimization support method according to an aspect of the present disclosure includes: acquiring information regarding a problem to be optimized; converting information regarding the problem to be optimized into an intermediate expression representing a feature of the information regarding the problem to be optimized; selecting, based on the converted intermediate expression, a solution to be applied to the problem to be optimized from a solution associated with an intermediate expression representing a feature of a problem suitable for application; and outputting information regarding the selected solution.

A non-transitory computer readable recording medium according to an aspect of the present disclosure storing an optimization support program causes a computer to execute: acquiring information regarding a problem to be optimized; converting information regarding the problem to be optimized into an intermediate expression representing a feature of the information regarding the problem to be optimized; selecting, based on the converted intermediate expression, a solution to be applied to the problem to be optimized from a solution associated with an intermediate expression representing a feature of a problem suitable for application; and outputting information regarding the selected solution.

### BRIEF DESCRIPTION OF THE DRAWINGS

FIG. 1 is a diagram illustrating an example of a configuration of an optimization system according to the example embodiment of the present disclosure;

FIG. 2 is a diagram illustrating an example of a configuration of an optimization support device according to the example embodiment of the present disclosure;

FIG. 3 is a diagram illustrating an example of information indicating content of a problem to be optimized according to the example embodiment of the present disclosure;

FIG. 4 is a diagram illustrating an example of information indicating content of a problem to be optimized according to the example embodiment of the present disclosure;

FIG. 5 is a diagram illustrating an example of information indicating content of a problem to be optimized according to the example embodiment of the present disclosure;

FIG. 6 is a diagram illustrating an example of a selection result of a solution to a problem to be optimized according to the example embodiment of the present disclosure;

FIG. 7 is a diagram illustrating an example of a configuration of an optimization system according to the example embodiment of the present disclosure;

FIG. 8 is a diagram illustrating an example of an operation flow of the optimization support device according to the example embodiment of the present disclosure; and

FIG. 9 is a diagram illustrating an example of a hardware configuration according to the example embodiment of the present disclosure.

### EXAMPLE EMBODIMENT

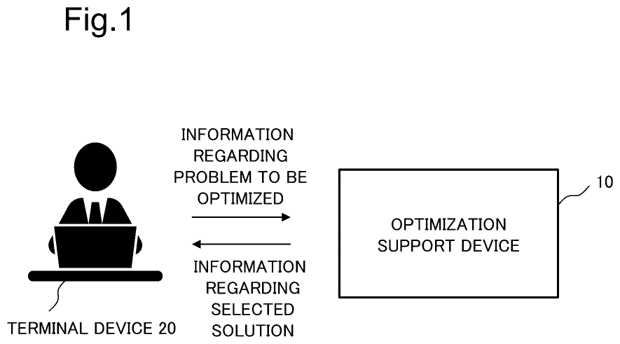

Example embodiments of the present disclosure will be described in detail with reference to the drawings. FIG. 1 is a diagram illustrating an example of a configuration of an optimization system. The optimization system includes, for example, an optimization support device 10 and a terminal device 20. The optimization support device 10 is connected to the terminal device 20 via, for example, a network. The number of terminal devices 20 can be appropriately set.

The optimization system selects, for example, a solution to be applied to the problem to be optimized. The problem to be optimized is, for example, an event for which a solution to the problem is to be estimated using an optimization solution. For example, the problem to be optimized is an event for which an optimal solution is to be estimated by mathematical optimization. The solution applied to the optimization problem is, for example, a heuristic used to solve the problem to be optimized. The heuristic is, for example, an approximate solution for deriving a solution to a problem to be optimized. The solution applied to the optimization problem may be meta-heuristic. The solution applied to the optimization problem may be a strict solution. The solution to be selected can include a solver used for a process of deriving a solution to the problem to be optimized. The solver is, for example, software that performs processing of deriving a solution to a problem to be optimized. The optimal solution may include a solution in a range suitable as a solution for the problem to be optimized. That is, the optimal solution for the problem to be optimized is not limited to one solution.

The optimization system selects a solution to be applied to the problem to be optimized from, for example, a solution stored as a database. The solutions are stored, for example, in association with information indicating the features of the problem suitable for each solution. Information indicating the feature of the problem suitable for each solution is stored as, for example, an intermediate expression. The intermediate expression is data obtained by converting each of the information regarding the problem to be optimized and the information indicating the feature of the problem suitable for each solution. For example, the intermediate expression is data converted to be suitable for determining the degree of coincidence between the problem to be optimized and the problem associated with each solution. A specific example of the intermediate expression will be described later.

For example, the optimization system selects a solution to be applied to the problem to be optimized from a solution associated with the intermediate expression representing the feature of the problem suitable for application based on the intermediate expression converted from the information regarding the problem to be optimized. The information regarding the problem to be optimized is, for example, information indicating the content of the problem to be optimized. For example, the information indicating the content of the problem to be optimized is information indicating the setting and constraint of the problem to be optimized. By selecting a solution based on the intermediate expression, the optimization system can select a solution to be applied to the problem to be optimized, for example, even if the notation of the information indicating the content of the problem to be optimized is different. A person in charge who performs an operation of estimating a solution of a problem to be optimized refers to, for example, a selection result of a solution to be applied to the problem to be optimized, and determines a solution to be actually applied to the problem to be optimized.

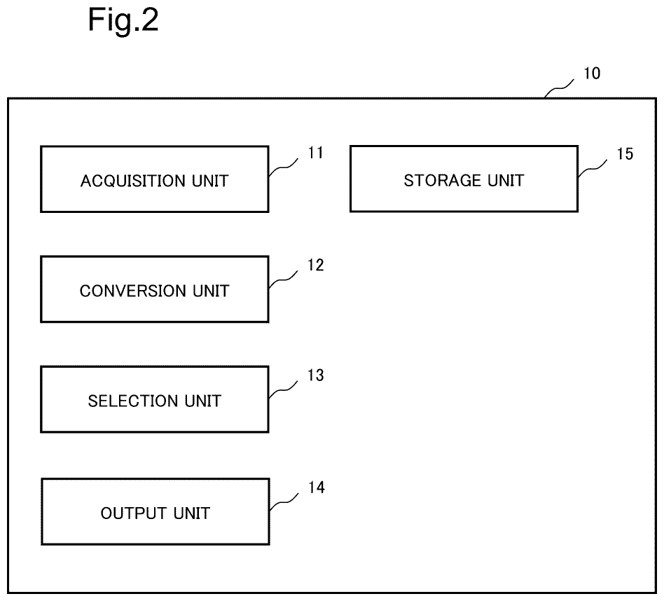

Here, an example of a configuration of the optimization support device 10 will be described. FIG. 2 is a diagram illustrating an example of a configuration of the optimization support device 10. The optimization support device 10 includes an acquisition unit 11, a conversion unit 12, a selection unit 13, and an output unit 14 as a basic configuration. The optimization support device 10 may further include a storage unit 15.

The acquisition unit 11 acquires information regarding a problem to be optimized. For example, the acquisition unit 11 acquires a sentence indicating the setting and constraint of the problem to be optimized as information indicating the content of the problem to be optimized. The acquisition unit 11 may acquire an equation indicating the setting and constraint of the problem to be optimized as the information indicating the content of the problem to be optimized. The acquisition unit 11 may acquire a sentence and an equation indicating the setting and constraint of the problem to be optimized as the information indicating the content of the problem to be optimized.

The acquisition unit 11 acquires, for example, information regarding the problem to be optimized from the terminal device 20. The acquisition unit 11 inputs the information regarding the problem to be optimized to, for example, the terminal device 20 by a person in charge who performs work of estimating a solution of the problem to be optimized.

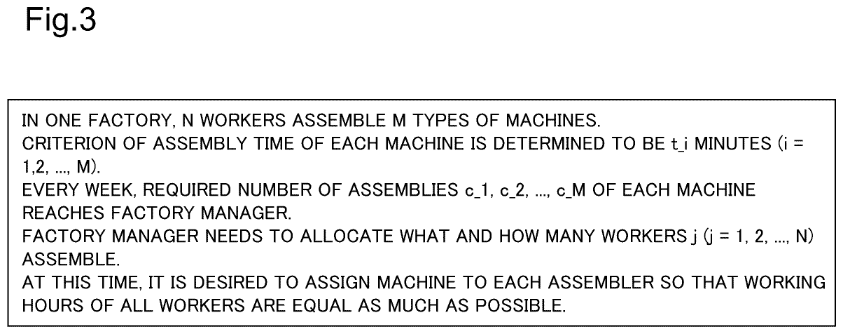

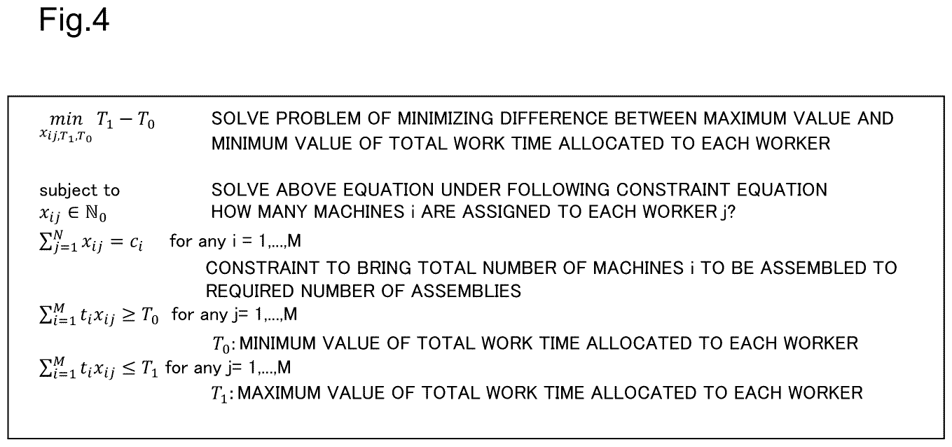

FIGS. 3 and 4 are examples of information indicating the content of the problem to be optimized. An example of the information indicating the content of the problem to be optimized illustrated in FIG. 3 is a sentence indicating the setting and constraint of the problem to be optimized. In the example of FIG. 3, the setting and constraint of the problem to be optimized are indicated by sentences. In the example of the information indicating the content of the problem to be optimized illustrated in FIG. 4, the setting and constraint of the problem to be optimized are illustrated using an equation. The example of FIG. 4 is an equation indicating the setting and constraint of a problem having the same contents as the problem to be optimized illustrated in the example of FIG. 3. In the example of FIG. 4, a sentence indicating the content of each equation is associated with each equation.

The information regarding the problem to be optimized may be information indicating a feature of the problem to be optimized. The information indicating the feature of the problem to be optimized is information indicating one or more of fields to which the problem to be optimized is applied, an optimization purpose, an optimization index, a variable used for optimization, and a function used for optimization. The information indicating the feature of the problem to be optimized is, for example, a keyword indicating the feature of the problem to be optimized. A plurality of keywords may be used. The information indicating the feature of the problem to be optimized may be a sentence in which the person in charge expresses the feature of the problem to be optimized. The person in charge is, for example, a person who performs work of estimating a solution of a problem to be optimized. The information indicating the feature of the problem to be optimized is not limited to the above. The information regarding the problem to be optimized is not limited to the above.

The acquisition unit 11 may acquire information indicating a part of the content of the problem to be optimized as the information regarding the problem to be optimized. For example, in a case where the person in charge inputs a sentence indicating a part of the content of the problem to be optimized, the acquisition unit 11 acquires the input sentence as information indicating a part of the content of the problem to be optimized. In this case, the person in charge is, for example, a person who performs work of estimating the solution of the problem to be optimized.

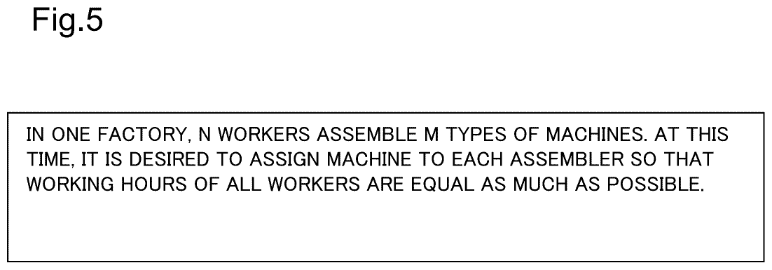

FIG. 5 is an example of a sentence indicating a part of the content of the problem to be optimized. The example of the sentence of FIG. 5 illustrates, for example, the content of a part of the content of the problem to be optimized illustrated in the sentence of FIG. 3. When performing the work of estimating the solution of the problem to be optimized, the person in charge can obtain a solution to be applied to the problem to be optimized by inputting a sentence as illustrated in the example of FIG. 5 to the optimization support device 10 via the terminal device 20, for example.

The acquisition unit 11 may acquire an image indicating the content of the problem to be optimized as the information regarding the problem to be optimized. The image indicating the content of the problem to be optimized is, for example, a photograph or a drawing indicating the content of the problem to be optimized. The image indicating the content of the problem to be optimized is not limited to the above. The acquisition unit 11 may acquire a table indicating the content of the problem to be optimized as the information regarding the problem to be optimized. The acquisition unit 11 may acquire voice data indicating the content of the problem to be optimized as the information regarding the problem to be optimized. The form of the information regarding the problem to be optimized is not limited to the above.

The acquisition unit 11 may acquire a solution and information indicating a feature of a problem associated with the solution. For example, the acquisition unit 11 may acquire the information indicating the feature of the problem associated with the solution in a state where the information is not converted into the intermediate expression. The information indicating the feature of the problem associated with the solution is, for example, information in the same form as the information regarding the problem to be optimized.

The conversion unit 12 converts the information regarding the problem to be optimized into an intermediate expression that is data representing a feature of the problem to be optimized. For example, the conversion unit 12 converts information regarding the problem to be optimized into an intermediate expression used for selecting a solution to be applied to the optimization target. For example, the intermediate expression converted from the information regarding the problem to be optimized is, for example, data from which a solution suitable for the problem to be optimized can be selected by comparing with the intermediate expression indicating the feature of the problem associated with the solution. For example, the conversion unit 12 converts information regarding the problem to be optimized into an intermediate expression used for selection of a solution associated with a problem similar to the problem to be optimized. “Similar” means that, for example, when the same solution is used, an appropriate solution can be obtained in any problem. For example, the information regarding the problem to be optimized is set as a first intermediate expression, and the intermediate expression indicating the feature of the problem associated with the solution is set as a second intermediate expression. In this case, for example, the conversion unit 12 converts the information regarding the problem to be optimized into the first intermediate expression based on the similarity between the first intermediate expression and the second intermediate expression so that a solution suitable for the problem to be optimized can be selected.

For example, the conversion unit 12 converts the information regarding the problem to be optimized into an intermediate expression that is data representing the feature of the problem to be optimized using a conversion model. The conversion model is, for example, a machine learning model that converts information regarding a problem to be optimized into an intermediate expression using the information regarding the problem to be optimized as an input. For example, the conversion model converts the information regarding the problem to be optimized into the intermediate expression such that the intermediate expressions having similar information regarding the problem to be optimized before the conversion are similar to each other. The conversion model uses, for example, a natural language processing method to convert a sentence indicating the content of the problem to be optimized into a feature vector that is an intermediate expression. For example, the conversion model converts the information regarding the problem to be optimized into a feature vector such that the feature vectors converted from the information regarding the problem to be optimized similar to each other are similar to each other.

The conversion model is generated by using, for example, a sentence indicating the features of a plurality of problems and data indicating whether the sentences are the same as each other as learning data. In the generation stage of the conversion model, for example, in a case where two sentences are similar to each other, the conversion model performs learning so as to convert the sentence indicating the features of the plurality of problems into the feature vector so that the distance between the feature vectors to be converted from the sentences becomes short. In this case, “being similar” means that, for example, expressions are different but sentences indicate the same content. For example, in the conversion model, in a case where two sentences indicate the same content, learning is performed such that the distance between the feature vectors converted from the sentences becomes short. For example, in a case where the two sentences are not the same, the conversion model is learned to convert the sentences indicating the features of the plurality of problems into the feature vectors so that the distance between the feature vectors to be converted from the sentences is increased. The conversion model is generated by deep learning using a neural network, for example.

The conversion unit 12 may convert the information regarding the problem to be optimized into an intermediate expression by normalizing an equation included in the information regarding the problem to be optimized. For example, the conversion unit 12 normalizes the equation included in the information regarding the problem to be optimized by transforming the equation into another expression having the same value. For example, the conversion unit 12 normalizes the equation by performing processing of one or more of alignment of notations of symbols, generalization of numerical information, and typical transformation.

The alignment of notations means, for example, unifying the characters included in the equation according to the standard. For example, in a case where “a”, “b”, and “c” are used as variables in an equation included in the information regarding the problem to be optimized, when it is specified in the criterion that “x”, “y”, and “z” are used as variables, the conversion unit 12 replaces “a”, “b”, and “c” with “x”, “y”, and “z”. Such conversion is relevant to, for example, alignment of notations of symbols. For example, in a case where numerical information of “3 persons” is included in the information regarding the problem to be optimized, the conversion unit 12 generalizes by replacing “3 persons” with “M persons”. Such conversion is relevant to, for example, generalization of numerical information. For example, in a case where the inequality is included in the information regarding the problem to be optimized, the conversion unit 12 moves the variable to the left side and the constant to the right side. Such conversion is relevant to a typical transformation, for example. The conversion unit 12 normalizes an equation included in the information regarding the problem to be optimized based on the set rule. The conversion unit 12 may normalize an equation included in the information regarding the problem to be optimized using the conversion model. In this case, the conversion model is generated by, for example, reinforcement learning.

The conversion unit 12 may convert the equation included in the information regarding the problem to be optimized into the intermediate expression by converting the normalized equation into the feature vector. For example, the conversion unit 12 converts the equation included in the information regarding the problem to be optimized into the intermediate expression by converting the normalized equation into the feature vector using the conversion model.

In a case where an equation included in the information regarding the problem to be optimized is converted into the intermediate expression, the conversion model is generated as follows, for example. For example, a learning device that generates the conversion model executes learning of the conversion model so as to be a model that performs conversion such that a distance between a feature vector converted from an equation included in the problem and a feature vector converted from an equation obtained by randomly applying and transforming an allowable operation on the equation becomes short. The learning device that generates the conversion model executes learning of the conversion model so as to be a model that converts the feature vector converted from the equation included in the problem and the feature vector converted from the equation of another problem so as to increase the distance, for example. The conversion model is generated by deep learning using a neural network, for example. The algorithm for generating the conversion model for converting each of the sentence and the equation into the feature vector is not limited to the above.

The conversion model that converts the sentence indicating the information regarding the problem to be optimized into the intermediate expression and the conversion model that converts the equation included in the information regarding the problem to be optimized into the intermediate expression may be the same machine learning model, or may be another machine learning model. The conversion model may convert the information indicating the content of the problem in which the equation and the sentence are mixed into the intermediate expression.

In a case where information other than a sentence and an equation is included in the information regarding the problem to be optimized, the conversion unit 12 may convert the information other than the sentence and the equation included in the information regarding the problem to be optimized into the intermediate expression using a conversion model that converts the information other than the sentence and the equation into the intermediate expression. The information other than the sentence and the equation included in the information regarding the problem to be optimized is, for example, information in one or more forms of images, drawings, and tables. The information other than the sentence and the equation included in the information regarding the problem to be optimized is not limited to the above.

In a case where the object to be converted into the intermediate expression is an image, a diagram, or a table, the conversion model identifies the image, the diagram, or the table by using, for example, an image recognition technology. Then, the conversion model converts the identification result into the intermediate expression.

For example, in a case where the object to be converted into the intermediate expression is an image, the conversion model uses the image recognition technology to identify an object or the state of the object appearing in the image. Then, the conversion model converts the image to be converted into the intermediate expression into the intermediate expression, for example, by converting the object or the state of the object appearing in the image into a feature vector.

For example, in a case where the object to be converted into the intermediate expression is a drawing, the conversion model uses the image recognition technology to identify the structure of the object drawn in the drawing. For example, the conversion model uses the image recognition technology to identify points that are indicative of features of the structure of the object depicted in the drawing. Then, the conversion model converts the drawing to be converted into the intermediate expression into the intermediate expression, for example, by converting points indicating features of the structure of the identified object into feature vectors.

For example, in a case where the object to be converted into the intermediate expression is a table, the conversion model uses the image recognition technology to identify characters and numerical values included in the table. Then, the conversion model converts the table to be converted into the intermediate expression into the intermediate expression, for example, by converting the identified characters and numerical values into the feature vector.

The conversion model may be a machine learning model that converts a sentence and an equation included in the information regarding the problem to be optimized and information other than the sentence and the equation into an intermediate expression. As described above, the machine learning model that converts data in a plurality of forms is also referred to as a multimodal model.

The conversion unit 12 may convert the information regarding the problem to be optimized into the intermediate expression by extracting a keyword from the information regarding the problem. In this case, the intermediate expression is, for example, a keyword extracted from the information regarding the problem to be optimized. For example, the conversion unit 12 extracts a keyword representing the feature of the content of the problem from the information regarding the problem to be optimized. For example, in a case where the information regarding the problem to be optimized is the sentence illustrated in the example of FIG. 3, the conversion unit 12 converts the information regarding the problem to be optimized into the intermediate expression by extracting “working hours”, “equal”, “assembly”, and “allocation” as keywords. The keyword to be extracted is set as, for example, a dictionary. The conversion unit 12 may convert the information regarding the problem to be optimized into the intermediate expression by converting the keyword extracted from the information regarding the problem to be optimized into the synonymous keyword. In this case, the keyword before conversion and the keyword after conversion are set as data associated with each other. Also, synonymous keywords may include similar words. For example, in a case where the keyword of “equal” is extracted from the sentence illustrated in the example of FIG. 3, the conversion unit 12 converts “equal” into “equivalent”.

The conversion unit 12 extracts a keyword and converts the keyword into a synonymous keyword by using a well-known natural language processing method. The conversion unit 12 may extract a keyword and convert the keyword into a synonymous keyword by using information regarding the problem to be optimized as an input to the language model. For example, Word2Sec can be used as the language model. As the language model, Generative Pre-trained Transformer-2 (GPT-2), GPT-3, GPT-3.5, or GPT-4 can be used. Claude3, text-to-text transfer transformer (T5), bidirectional encoder representations from transformers (BERT), robustly optimized BERT approach (RoBERTa), or efficiently learning an encoder that classifies token replacements accurately (ELECTRA) may be used as the language model. The language model is not limited to the above.

In a case where the information indicating the feature of the problem associated with the solution is acquired in a state of not being converted into the intermediate expression, the conversion unit 12 may convert the information indicating the feature of the problem associated with the solution into the intermediate expression. For example, the conversion unit 12 converts the feature of the problem associated with the solution into the intermediate expression using a method similar to the method of converting the information regarding the problem to be optimized into the intermediate expression.

The selection unit 13 selects a solution to be applied to the problem to be optimized from the solutions associated with the intermediate expression representing the feature of the problem suitable for application based on the intermediate expression obtained by converting the information regarding the content of the problem to be optimized.

For example, the selection unit 13 selects a solution to be applied to the problem to be optimized based on a score indicating the suitability as a solution to be applied to the problem to be optimized. The score indicating the suitability as a solution to be applied to the problem to be optimized is, for example, an index indicating how suitable the score is as a solution to be applied to the problem to be optimized. The suitability degree as a solution to be applied to the problem to be optimized is set, for example, such that the higher the suitability of the solution as a solution to be applied to the problem to be optimized, the higher the score of the solution. As the score indicating the suitability as the solution to be applied to the problem to be optimized, for example, the similarity between the intermediate expression obtained by converting the information regarding the content of the problem to be optimized and the intermediate expression associated with the solution is used. The score may be weighted, for example, based on at least one of empirical performance and ease of implementation of each solution. By performing weighting, for example, in a case where scores based on similarity are the same, an appropriate solution can be selected from the viewpoint of performance and implementation. The weights regarding the empirical performance and the ease of implementation are set by, for example, a person in charge who performs an operation of estimating a solution of the problem to be optimized. For example, the selection unit 13 calculates a weighted score by multiplying the score based on the similarity by a set weight. For example, the intermediate expression converted from the information regarding the problem to be optimized is referred to as a first intermediate expression, and the intermediate expression associated with the solution is referred to as a second intermediate expression. In this case, when the similarity of the intermediate expression is used as the score, the selection unit 13 selects a solution to be applied to the problem to be optimized based on, for example, the similarity between the first intermediate expression and the second intermediate expression.

In a case where the similarity of the intermediate expressions is used as a score, when the intermediate expression is a feature vector, the score is, for example, the similarity between the feature vector obtained by converting the information regarding the content of the problem to be optimized and the feature vector associated with the solution. The similarity between the feature vector obtained by converting the information regarding the content of the problem to be optimized and the feature vector associated with the solution is, for example, a Euclidean distance or a cosine similarity between the feature vectors. The similarity in a case where the intermediate expression is a feature vector is not limited to the above. In this case, the score becomes higher, for example, as the intermediate expressions are more similar to each other.

The selection unit 13 may calculate the score based on the intermediate expression converted for each classification of the information indicating the content of the problem to be optimized. The classification of information is, for example, a classification indicating what role information plays in a problem. The classification of the information is, for example, a classification indicating which of the setting of the problem, the constraint, and the optimization criterion the sentence is. The classification of the information is not limited to the above.

For example, in a case where the intermediate expression is a feature vector converted from a sentence, the selection unit 13 calculates similarity between the feature vector converted from the problem to be optimized and the feature vector associated with the solution based on, for example, the feature vector converted from each of sentences indicating the setting, constraint, and optimization criterion of the problem. Then, the selection unit 13 calculates an average value of the calculated similarities as a score. In a case where the intermediate expression is a feature vector converted from an equation, the selection unit 13 calculates similarity between the feature vector converted from the problem to be optimized and the feature vector associated with the solution based on the feature vector converted from each of the equations indicating the setting, constraint, and optimization criterion of the problem. Then, the selection unit 13 calculates an average value of the calculated similarities as a score. The selection unit 13 may calculate the score using a statistic other than the average value regarding the similarity.

The selection unit 13 may calculate a score by weighting the similarity calculated for each classification of information. For example, the selection unit 13 calculates a score by weighting each of the similarity of the feature vector converted from the information indicating the problem setting, the similarity of the feature vector converted from the information indicating the constraint, and the similarity of the feature vector converted from the information indicating the optimization criterion. The weight of each classification of information is set by, for example, a person in charge of estimating a solution of the problem to be optimized or an administrator of the optimization support device 10.

In a case where the intermediate expression is a normalized equation, the score may be an index indicating a matching degree of the normalized equation. For example, the selection unit 13 calculates, as a score, a matching degree between the normalized equation associated as the intermediate expression with the problem to be optimized and the normalized equation associated as the intermediate expression with the solution. Then, the selection unit 13 selects a solution to be applied to the problem to be optimized based on the calculated score. For example, the selection unit 13 calculates, as a score, a ratio of a matched equation to the total number of equations included in the information regarding the problem to be optimized.

In a case where the intermediate expression is a normalized equation, the selection unit 13 may calculate the matching degree for each classification of the equation. The classification of the equation is, for example, a classification indicating what role the equation plays in the problem. The classification of the equation is, for example, a classification indicating which one of a problem setting, a constraint, and an optimization criterion the equation is. The classification of the equation is not limited to the above. For example, in a case where there are an equation obtained by normalizing an equation indicating a problem setting, an equation obtained by normalizing an equation indicating a constraint, and an equation obtained by normalizing an equation indicating an optimization criterion, the selection unit 13 calculates the matching degree for each classification of the equations. Then, for example, the selection unit 13 calculates an average value of the calculated matching degrees as a score. The selection unit 13 may calculate the score using a statistic other than the average value regarding the matching degree.

The selection unit 13 may calculate the score by weighting the matching degree calculated for each classification of the equation. For example, the selection unit 13 calculates a score by weighting each of the matching degree of the equation obtained by normalizing the equation indicating the problem setting, the matching degree of the equation obtained by normalizing the equation indicating the constraint, and the matching degree of the equation obtained by normalizing the equation indicating the optimization criterion. The weight of each classification of the equation is set by, for example, a person in charge of estimating the solution of the problem to be optimized or an administrator of the optimization support device 10.

The selection unit 13 selects, for example, a solution having the highest score as a solution to be applied to the problem to be optimized. For example, in a case where the score is the similarity of the intermediate expression, the selection unit 13 selects a solution associated with the intermediate expression having a highest similarity with the intermediate expression obtained by converting the information regarding the content of the problem to be optimized as a solution to be applied to the problem to be optimized.

The selection unit 13 may select a plurality of solutions as solutions to be applied to the problem to be optimized. For example, the selection unit 13 selects a solution whose score satisfies the criterion as a solution to be applied to the problem to be optimized. The score criterion is set such that, for example, a solution in which the score satisfies the criterion is suitable as a solution for solving the problem to be optimized. The selection unit 13 may select a predetermined number of solutions whose scores satisfy the criterion from the top as solution candidates to be applied to the problem to be optimized. The selection unit 13 may select a predetermined number of solutions whose scores satisfy the criterion from the top as solution candidates to be applied to the problem to be optimized. The predetermined number is set such that details of a plurality of solutions can be confirmed as solution candidates to be applied to the problem to be optimized, and the workload for confirmation is not enormous.

The selection unit 13 may transform an equation included in the information regarding the problem to be optimized, and select a solution to be applied to the problem based on the matching degree between the transformed equation and an equation associated with the solution. For example, the selection unit 13 calculates, as a score, a ratio of a matched equation to the total number of equations included in the information regarding the problem to be optimized. For example, the selection unit 13 transforms the equation included in the information regarding the problem to be optimized based on the criterion for converting the equation. Then, the selection unit 13 selects a solution in which an equation having a highest matching degree is associated with an equation obtained by converting an equation included in the information regarding the problem to be optimized as a solution to be applied to the problem to be optimized. The selection unit 13 may perform transformation of the equation after performing normalization. The criterion for transforming the equation is set as, for example, data in which the equation to be transformed and the transformed equation are associated with each other. The criterion for transforming the equation is set as, for example, data in which a term and a symbol included in the equation to be transformed are associated with a transformation method of the term and the symbol.

The selection unit 13 may use an equation transformation model to transform the equation included in the information regarding the problem to be optimized. The equation transformation model is a machine learning model that outputs a transformed equation using the equation as an input. The equation transformation model is generated by, for example, reinforcement learning. The learning device that generates the equation transformation model transforms the equation included in the problem to be optimized using, for example, the equation transformation model. The learning device that generates the equation transformation model calculates, for example, the matching degree between the transformed equation and the equation having the same content as the equation. Then, the learning device learns the equation transformation model so that, for example, a matching degree between the transformed equation and the equation equivalent to the equation is improved.

The selection unit 13 may select a solution to be applied to the problem to be optimized based on the matching degree between the equation obtained by transforming the equation included in the problem to be optimized and the solution whose score satisfies the criterion for performing the equation transformation. The score is, for example, a score indicating the suitability as a solution to be applied to the problem to be optimized. For example, the selection unit 13 sets an equation associated with a solution whose score satisfies the criterion for performing the equation transformation as a target for calculating the matching degree with the transformed equation. That is, for example, the selection unit 13 extracts solution candidates by calculating the score, and selects a solution to be applied to the problem to be optimized from among the candidates extracted based on the matching degree calculated by the transformation of the equation.

The selection unit 13 may select a solution to be applied to the problem to be optimized from the hierarchical solutions. In a case where a solution to be applied to the problem to be optimized is selected from the hierarchized solutions, the selection unit 13 selects a solution candidate to be applied to the problem to be optimized from the solutions of the upper layers based on the score, for example. Then, the selection unit 13 selects a solution to be applied to the problem to be optimized from the solutions associated with the extracted solution based on the score.

“Hierarchical” means that, for example, a solution generated by deriving from the solution is associated with the solution as a solution of a lower layer. The derived solution means, for example, a solution in which a part of the solution is changed. For example, if some of the constraints of Solution A are changed to generate Solution B and Solution C, Solution B and Solution C are, for example, solutions for derivation of Solution A. For example, Solution B and Solution C are solutions of a lower layer of Solution A. That is, Solution A is, for example, an upper layer than Solution B and Solution C. The derived solution may be a solution in which a part of the solution is changed based on the change content of the problem in a case where the part of the problem is changed. The change may also include the addition of the content of the problem. For example, when some of the constraints are changed or added to a problem for which Solution A is appropriate, and Solution B and Solution C are more appropriate solutions, Solution B and Solution C are, for example, solutions for derivation of Solution A. The selection unit 13 selects a solution to be applied to the problem to be optimized from among Solution B and Solution C, for example, in a case where Solution A, which is the upper layer, is selected as a candidate for the solution.

The output unit 14 outputs information regarding the selected solution. The output unit 14 outputs, for example, information indicating the content of the selected solution. The information indicating the content of the selected solution is, for example, a sentence and an equation indicating the solution. The information indicating the content of the selected solution may be either a sentence or an equation indicating the solution. The output unit 14 may output identification information of the selected solution. The identification information is, for example, a number or a name of a solution. The identification information is not limited to the above. The output unit 14 may output a score indicating the suitability of the solution to the problem to be optimized for the selected solution. The output unit 14 may output identification information of a solution and a score for each solution as a list. For example, in a case where a solution is selected on the screen displaying the output list, the output unit 14 may output information indicating the content of the selected solution.

The output unit 14 outputs, for example, information regarding the selected solution to the terminal device 20. The output unit 14 may output information regarding the selected solution to an information processing device (not illustrated) that executes processing of deriving an optimal solution in the problem to be optimized.

The output unit 14 may further output a reason for selecting a solution to be applied to the problem to be optimized as the information regarding the selected solution. The output unit 14 outputs the reason for selecting the solution, for example, based on the transformation result of the equation included in the information regarding the problem. For example, in a case where the equation is transformed, the output unit 14 outputs the reason for selecting the solution based on the content of the transformation of the equation having the largest influence on the increase in the matching degree. The reason for selection may also be associated with the solution. In this case, the output unit 14 outputs the reason for selection associated with the solution as the reason for selection of the solution.

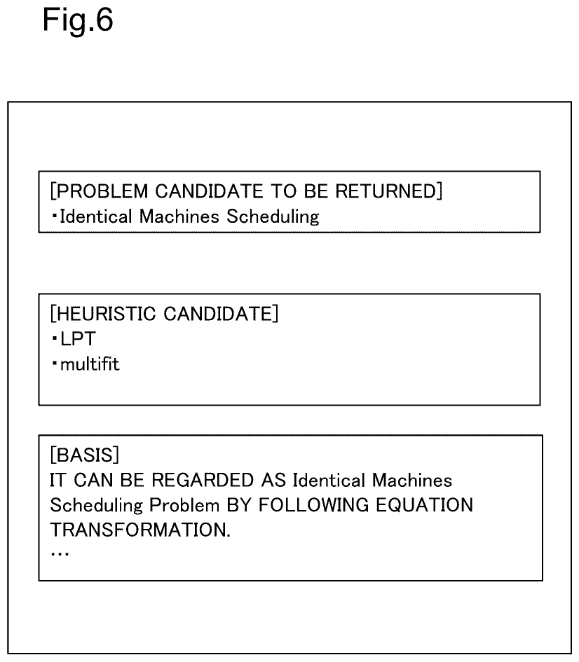

FIG. 6 is a diagram illustrating an example of a display screen of information regarding the selected solution. In the example of the display screen of FIG. 6, “problem candidate to be returned”, “solution candidate”, and “basis” are displayed. In the example of the display screen of FIG. 6, the “problem candidate to be returned” is the name of the problem associated with the solution to be applied to the problem to be optimized. For example, in the example of the display screen of FIG. 6, the “problem candidate to be returned” is the name of a problem having the same contents as the problem to be optimized. That is, in the example of the display screen of FIG. 6, the “problem candidate to be returned” is, for example, the name of the problem to be optimized. The “solution candidate” is a name of a solution selected as a solution to the problem to be optimized. In the candidates for the display screen in FIG. 6, “basis” is information indicating the basis for selecting a solution to be applied to the problem to be optimized. By referring to the example of the display screen in FIG. 6, the person in charge of estimating the solution of the problem to be optimized can estimate the solution of the problem to be optimized using a solution suitable for the problem to be optimized.

The storage unit 15 selects, for example, information regarding processing of selecting a solution to be applied to the problem to be optimized. The storage unit 15 stores, for example, information regarding the problem to be optimized. The storage unit 15 stores, for example, a selection result of a solution to be applied to the problem to be optimized. The storage unit 15 stores, for example, the conversion model. The storage unit 15 stores, for example, the equation transformation model. The conversion model and the equation transformation model may be stored in a storage means outside the optimization support device 10.

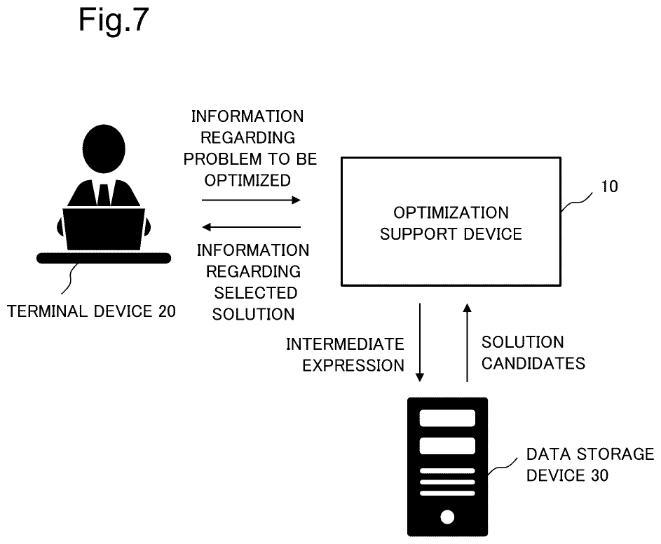

The storage unit 15 stores, for example, data in which an intermediate expression representing a feature of a problem suitable for application and a solution are associated with each other as a database. The database in which the intermediate expression representing the feature of the problem suitable for application and the solution are associated with each other may be stored in a storage means outside the optimization support device 10. FIG. 7 illustrates an example of an optimization system in which a database associating the intermediate expression representing a feature of a problem suitable for application with the solution is stored in a data storage device 30. In the example of the optimization system of FIG. 7, the data storage device 30 stores, for example, a database associating an intermediate expression representing a feature of a problem suitable for application with a solution.

In the optimization system illustrated in the example of FIG. 7, the selection unit 13 of the optimization support device 10 outputs the intermediate expression converted by the conversion unit 12 to the data storage device 30, for example, as a search query. The data storage device 30 selects a solution to be applied to the problem to be optimized based on the intermediate expression acquired as the search query. Then, the selection unit 13 acquires a solution to be applied to the selected problem to be optimized from the data storage device 30.

The terminal device 20 is, for example, a terminal device used by a person in charge who performs work of estimating a solution of a problem to be optimized. The terminal device 20 acquires, for example, information regarding the problem to be optimized input by a person in charge who performs work of estimating a solution of the problem to be optimized. Then, the terminal device 20 outputs information regarding the problem to be optimized to the acquisition unit 11 of the optimization support device 10, for example.

The terminal device 20 acquires, for example, information regarding the solution selected by the selection unit 13 of the optimization support device 10 from the output unit 14 of the optimization support device 10. The terminal device 20 outputs information regarding the selected solution to a display device (not illustrated), for example.

For example, the terminal device 20 may execute processing of deriving an optimal solution in the problem to be optimized using the solution acquired from the output unit 14 of the optimization support device 10. Then, the terminal device 20 outputs the derived optimal solution to a display device (not illustrated). The processing of deriving the optimal solution in the problem to be optimized using the solution selected by the optimization support device 10 may be performed by an execution means (not illustrated) inside the optimization support device 10.

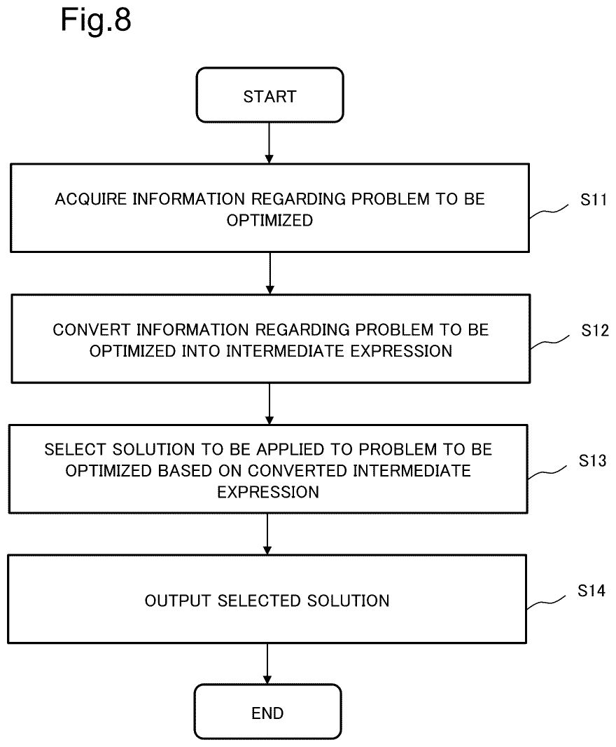

An operation of selecting a solution to be applied to a problem to be optimized in the optimization support device 10 will be described. FIG. 8 illustrates an example of an operation flow of processing of selecting a solution to be applied to a problem to be optimized in the optimization support device 10.

The acquisition unit 11 acquires information regarding the problem to be optimized (step S11). The acquisition unit 11 acquires, for example, information regarding the problem to be optimized from the terminal device 20.

When the information regarding the problem to be optimized is acquired, the conversion unit 12 converts the information regarding the problem to be optimized into an intermediate expression representing a feature of the information regarding the problem to be optimized (step S12).

When the information regarding the problem to be optimized is converted into the intermediate expression, the selection unit 13 selects a solution to be applied to the problem to be optimized from a solution associated with the intermediate expression representing the feature of the problem suitable for application based on the converted intermediate expression (step S13).

When the solution is selected, the output unit 14 outputs information regarding the selected solution (step S14). The output unit 14 outputs, for example, information regarding the selected solution to the terminal device 20.

The optimization support device 10 converts the information regarding the problem to be optimized into an intermediate expression representing a feature of the information regarding the problem to be optimized. Then, the optimization support device 10 selects a solution to be applied to the problem to be optimized from the solutions associated with the intermediate expression representing the feature of the problem suitable for application based on the converted intermediate expression. As described above, the optimization support device 10 can easily select a solution suitable for the problem to be optimized by selecting based on the intermediate expression representing the feature of the information regarding the problem to be optimized.

For example, by converting the information indicating the content of the problem to be optimized into the intermediate expression, the optimization support device 10 can select a solution suitable for the problem to be optimized even in a case where there is a difference in the expression method. For example, in a case where a heuristic suitable for each problem is stored in the database as a solution, the optimization support device 10 can select a solution suitable for the problem to be optimized from among many subdivided solutions by converting the information indicating the content of the problem to be optimized into the intermediate expression. Therefore, the optimization support device 10 can improve the accuracy of selecting a solution suitable for the problem to be optimized.

For example, the optimization support device 10 can efficiently select a solution more suitable for the problem to be optimized by selecting a solution candidate to be applied to the problem to be optimized using the score, transforming the mathematical expression indicating the content of the problem to be optimized, and selecting a solution suitable for the problem to be optimized based on the matching degree with the equation included in the solution.

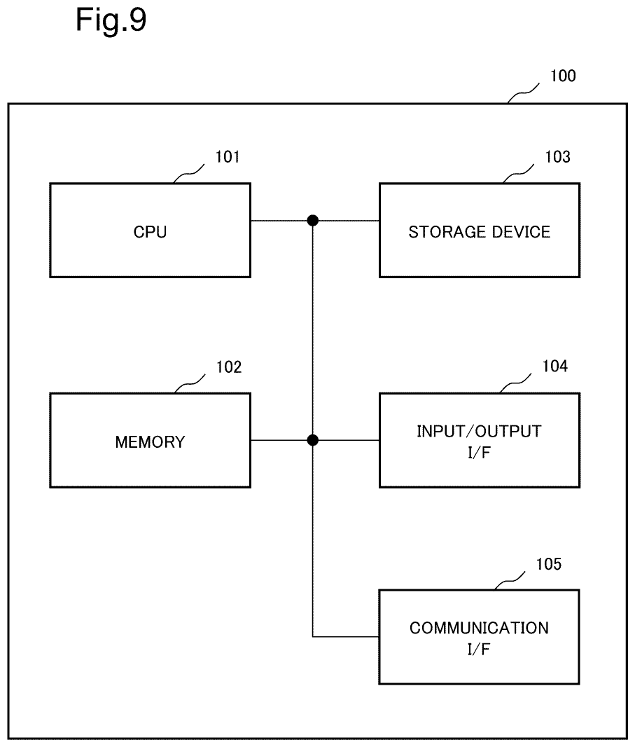

Each process in the optimization support device 10 can be implemented by executing a computer program on a computer. FIG. 9 illustrates an example of a configuration of a computer 100 that executes a computer program for executing each process in the optimization support device 10. The computer 100 includes a central processing unit (CPU) 101, a memory 102, a storage device 103, an input/output interface (I/F) 104, and a communication I/F 105.

The CPU 101 reads and executes a computer program for executing each processing from the storage device 103. The CPU 101 may be configured by a combination of a plurality of CPUs. The CPU 101 may be configured by a combination of the CPU and another type of processor. For example, the CPU 101 may be configured by a combination of a CPU and a graphics processing unit (GPU). The memory 102 includes a dynamic random access memory (DRAM) or the like, and temporarily stores a computer program executed by the CPU 101 and data being processed. The storage device 103 stores a computer program executed by the CPU 101. The storage device 103 includes, for example, a nonvolatile semiconductor storage device. The storage device 103 may include another storage device such as a hard disk drive. The input/output I/F 104 is an interface that receives an input from an operator to output display data and the like. The communication I/F 105 is an interface that transmits and receives data to and from the terminal device 20, the data storage device 30, and other information processing devices. The terminal device 20 and the data storage device 30 may have the same configuration as the computer 100.

As a solution for a problem to be optimized, for example, a strict solution for strictly obtaining an optimal solution or an approximate solution is used. The approximate solution is, for example, meta-heuristic or heuristic. Software capable of executing each solution may be used. The software capable of executing each solution is called, for example, a solver. The solution to be applied to the problem to be optimized is selected based on the setting and constraint of the problem to be optimized. In the optimization problem, for example, it is required to derive a sufficiently accurate solution within an allowable time on an actual data scale. Therefore, in the optimization problem, it may be required to select a solution suitable for the problem to be optimized. However, with the technology described in the background art, it may be difficult to select a solution suitable for the problem to be optimized.

Therefore, in order to solve the above problem, an object of the present disclosure is to provide an optimization support device and the like that can easily select a solution suitable for a problem to be optimized.

According to the present disclosure, it is possible to easily select a solution suitable for a problem to be optimized.

The computer program used for executing each processing can also be distributed by being stored in a computer-readable recording medium that non-transiently records data. The recording medium can include, for example, a magnetic tape for data recording or a magnetic disk such as a hard disk. The recording medium may include an optical disk such as a compact disc read only memory (CD-ROM). A non-volatile semiconductor storage device may be used as a recording medium.

Some or all of the above-described example embodiments may be described as the following Supplementary Notes, but are not limited to the following Supplementary Notes.

### Supplementary Note 1

An optimization support device including:
an acquisition unit that acquires information regarding a problem to be optimized;
a conversion unit that converts information regarding the problem to be optimized into an intermediate expression representing a feature of the information regarding the problem to be optimized;
a selection unit that select, based on the converted intermediate expression, a solution to be applied to the problem to be optimized from a solution associated with an intermediate expression representing a feature of a problem suitable for application; and
an output unit that outputs information regarding the selected solution.

### Supplementary Note 2

The optimization support device according to Supplementary Note 1, in which the conversion unit converts the information regarding the problem to be optimized into the intermediate expression used for selection of a solution associated with a problem similar to the problem to be optimized.

### Supplementary Note 3

The optimization support device according to Supplementary Note 2, in which the conversion unit converts the information regarding the problem to be optimized into the intermediate expression by converting a sentence included in the information regarding the problem to be optimized into a feature vector.

### Supplementary Note 4

The optimization support device according to Supplementary Note 2, in which the conversion unit converts the information regarding the problem to be optimized into the intermediate expression by normalizing an equation included in the information regarding the problem to be optimized.

### Supplementary Note 5

The optimization support device according to Supplementary Note 4, in which the conversion unit converts an equation included in the information regarding the problem to be optimized into the intermediate expression by converting the normalized equation into a feature vector.

### Supplementary Note 6

The optimization support device according to Supplementary Note 4 or 5, in which the selection unit transforms an equation included in the information regarding the problem, and selects a solution to be applied to the problem based on a matching degree between the transformed equation and an equation associated with the solution.

### Supplementary Note 7

The optimization support device according to Supplementary Note 6, in which the selection unit selects a solution to be applied to the problem to be optimized based on a matching degree between the transformed equation and an equation associated with a solution selected as a solution candidate to be applied to the problem to be optimized.

### Supplementary Note 8

The optimization support device according to Supplementary Note 2, in which the conversion unit converts the information regarding the problem to be optimized into the intermediate expression by extracting a keyword from the information regarding the problem to be optimized.

### Supplementary Note 9

The optimization support device according to Supplementary Note 7, in which the output unit further outputs a selection reason for the solution generated based on a transformation result of an equation included in the information regarding the problem to be optimized.

### Supplementary Note 10

The optimization support device according to any one of Supplementary Notes 1 to 9, in which the solution is a heuristic that estimates a solution of the problem to be optimized.

### Supplementary Note 11

An optimization support method including:
acquiring information regarding a problem to be optimized;
converting information regarding the problem to be optimized into an intermediate expression representing a feature of the information regarding the problem to be optimized;
selecting, based on the converted intermediate expression, a solution to be applied to the problem to be optimized from a solution associated with an intermediate expression representing a feature of a problem suitable for application; and
outputting information regarding the selected solution.

### Supplementary Note 12

A non-transitory computer readable recording medium storing an optimization support program for causing a computer to execute:
acquiring information regarding a problem to be optimized;
converting information regarding the problem to be optimized into an intermediate expression representing a feature of the information regarding the problem to be optimized;
selecting, based on the converted intermediate expression, a solution to be applied to the problem to be optimized from a solution associated with an intermediate expression representing a feature of a problem suitable for application; and
outputting information regarding the selected solution.

Some or all of the configurations described in Supplementary Notes 2 to 10 dependent on the above-described Supplementary Note 1 can also be dependent on Supplementary Notes 11 and 12 by the same dependency relationship as in Supplementary Notes 2 to 10. Furthermore, some or all of the configurations described as the Supplementary Notes can be similarly dependent on not only the Supplementary Notes 1, 11, and 12, but also various pieces of hardware and software, and various recording means or systems for recording software without departing from the above-described example embodiments.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. An optimization support device comprising:
at least one memory storing instructions; and
at least one processor configured to access the at least one memory and execute the instructions to:
acquire information regarding a problem to be optimized;
convert information regarding the problem to be optimized into an intermediate expression representing a feature of the information regarding the problem to be optimized;
select, based on the converted intermediate expression, a solution to be applied to the problem to be optimized from a solution associated with an intermediate expression representing a feature of a problem suitable for application; and
output information regarding the selected solution.

2. The optimization support device according to claim 1, wherein
the at least one processor is further configured to execute the instructions to:
convert the information regarding the problem to be optimized into the intermediate expression used for selection of a solution associated with a problem similar to the problem to be optimized.

3. The optimization support device according to claim 2, wherein
the at least one processor is further configured to execute the instructions to:
convert the information regarding the problem to be optimized into the intermediate expression by converting a sentence included in the information regarding the problem to be optimized into a feature vector.

4. The optimization support device according to claim 2, wherein
the at least one processor is further configured to execute the instructions to:
convert the information regarding the problem to be optimized into the intermediate expression by normalizing an equation included in the information regarding the problem to be optimized.

5. The optimization support device according to claim 4, wherein
the at least one processor is further configured to execute the instructions to:
convert an equation included in the information regarding the problem to be optimized into the intermediate expression by converting the normalized equation into a feature vector.

6. The optimization support device according to claim 4, wherein
the at least one processor is further configured to execute the instructions to:
transform an equation included in the information regarding the problem, and selects a solution to be applied to the problem based on a matching degree between the transformed equation and an equation associated with the solution.

7. The optimization support device according to claim 6, wherein
the at least one processor is further configured to execute the instructions to:
select a solution to be applied to the problem to be optimized based on a matching degree between the transformed equation and an equation associated with a solution selected as a solution candidate to be applied to the problem to be optimized.

8. The optimization support device according to claim 2, wherein
the at least one processor is further configured to execute the instructions to:
convert the information regarding the problem to be optimized into the intermediate expression by extracting a keyword from the information regarding the problem to be optimized.

9. The optimization support device according to claim 7, wherein
the at least one processor is further configured to execute the instructions to:
output a selection reason for the solution generated based on a transformation result of an equation included in the information regarding the problem to be optimized.

10. The optimization support device according to claim 1, wherein
the solution is a heuristic that estimates a solution of the problem to be optimized.

11. An optimization support method comprising:
acquiring information regarding a problem to be optimized;
converting information regarding the problem to be optimized into an intermediate expression representing a feature of the information regarding the problem to be optimized;
selecting, based on the converted intermediate expression, a solution to be applied to the problem to be optimized from a solution associated with an intermediate expression representing a feature of a problem suitable for application; and
outputting information regarding the selected solution.

12. A non-transitory computer readable recording medium storing an optimization support program for causing a computer to execute:
acquiring information regarding a problem to be optimized;
converting information regarding the problem to be optimized into an intermediate expression representing a feature of the information regarding the problem to be optimized;
selecting, based on the converted intermediate expression, a solution to be applied to the problem to be optimized from a solution associated with an intermediate expression representing a feature of a problem suitable for application; and
outputting information regarding the selected solution.
